(19) United States
(12) Patent Application Publication
(10) Pub. No.: US 2019/0315303 A1
(43) Pub. Date: Oct. 17, 2019

(54) VEHICLE CONSOLE INCLUDING AN AIRBAG ASSEMBLY

(71) Applicant: GM GLOBAL TECHNOLOGY OPERATIONS LLC, Detroit, MI (US)

(72) Inventors: Hamid G. KIA, Bloomfield Hills, MI (US); Mark W. VERBRUGGE, Troy, MI (US)

(73) Assignee: GM GLOBAL TECHNOLOGY OPERATIONS LLC, Detroit, MI (US)

(21) Appl. No.: 15/953,010

(22) Filed: Apr. 13, 2018

(51) Int. Cl. B60R 21/215; B60R 21/231; B62D 25/20; B60N 2/01; B60R 7/04

(52) U.S. Cl. CPC B60R 21/215; B60R 21/231; B62D 25/2009; B60R 11/0235; B60R 7/04; B60R 2021/23107; B60N 2/01

(57) ABSTRACT

A console for a vehicle cabin having a floor includes a base and a cover. The base includes a wall and an airbag. The wall has an inner surface, an outer surface, a top, and an opposing bottom. The inner surface defines an inner volume. The top defines a top opening of the inner volume. The airbag can deploy from the outer surface of the wall. The cover is coupled to the wall. The cover is movable between an open position and a closed position. The cover at least partially encloses the inner volume when in the closed position. In certain aspects, the wall includes an inner wall and an outer wall that cooperate to define a gap. The airbag is disposed in the gap. In certain aspects, one of the inner wall and the outer wall is integrally formed with the floor.

### INTRODUCTION

This section provides background information related to the present disclosure which is not necessarily prior art.

The present disclosure relates to a vehicle console that includes an airbag assembly.

Vehicles typically include one or more rows of forward-facing seats. For example, many vehicles include a front row having two seats (e.g., for a driver and a passenger) and one or more additional rows behind the front row. Those vehicles may include airbag assemblies that are mounted within a body of the vehicle, for example, in a steering wheel, a dashboard, or a ceiling.

### SUMMARY

This section provides a general summary of the disclosure, and is not a comprehensive disclosure of its full scope or all of its features.

In various aspects, the present disclosure provides a console for a vehicle cabin having a floor. The console includes a base and a cover. The base includes a wall and an airbag. The wall has an inner surface, an outer surface, a top, and an opposing bottom. The inner surface defines an inner volume. The top defines a top opening of the inner volume. The airbag can deploy from the outer surface of the wall. The cover is coupled to the wall. The cover is movable between an open position and a closed position. The cover at least partially encloses the inner volume when in the closed position.

In one aspect, a position of the airbag is fixed with respect to a frame of the vehicle.

In one aspect, the wall includes an inner wall and an outer wall. The inner wall and the outer wall cooperate to define a gap. The airbag is disposed in the gap.

In one aspect, one of the inner wall and the outer wall is integrally formed with the floor.

In one aspect, the wall is formed from or includes a polymer-fiber composite material.

In one aspect, the wall has a planar cross section parallel to the floor. The cross section substantially defines a geometric shape. The geometric shape is a circle, an oval, a triangle, a quadrilateral, a pentagon, a hexagon, a heptagon, or an octagon.

In one aspect, the bottom of the wall is in communication with the floor of the vehicle cabin. The floor has a front end, a rear end, a first side, an opposing second side, and a longitudinal axis extending from the front end to the rear end. The bottom of the wall defines an area of the floor that is spaced apart from the front end, the rear end, the first side, and the opposing second side.

In one aspect, the console further includes a display device. The display device is coupled to the base. The display device is configured to be visible from within the vehicle cabin.

In one aspect, the console is included in a vehicle cabin. The vehicle cabin also includes a seat. The seat is in communication with the floor. The seat defines a passenger area. The airbag is configured to engage with the passenger area.

In one aspect, the vehicle cabin includes a plurality of additional seats. The additional seats are in communication with the floor. Each of the additional seats defines an additional passenger area. The console includes an additional airbag configured to engage with the additional passenger area of each of the additional seats.

In one aspect, the passenger area of the seat faces the passenger area of at least one seat of the plurality of additional seats.

In other aspects, the present disclosure provides an interior structure for a vehicle. The interior structure includes a console and a floor. The console includes a wall and an airbag. The wall is formed from or includes a polymer-fiber composite. The wall has an inner surface, an outer surface, a top, and an opposing bottom. The inner surface defines an inner volume. The airbag can deploy from a surface of the console. The floor extends outwardly from the bottom of the wall with respect to the inner volume. The floor is integrally formed with the wall. The floor is formed from or includes the polymer-fiber composite.

In one aspect, the console further includes an inner wall. The inner wall is at least partially disposed within the inner volume. The wall and the inner wall cooperate to define a gap into which the airbag is disposed.

In one aspect, the top of the wall defines an opening. The console further includes a cover coupled to the top of the wall, the cover being configured to be movable between an open position and a closed position, wherein the cover at least partially encloses the inner volume when in the closed position.

In yet other aspects, the present disclosure provides a vehicle having a cabin. The vehicle includes an elongated console and a floor. The elongated console includes a wall and an airbag. The wall includes an inner surface, an outer surface, a top, and an opposing bottom, the inner surface defines an inner volume. The airbag can deploy from a surface of the wall. A position of the airbag is fixed with respect to a frame of the vehicle. The floor has a front end, a rear end, a first side, an opposing second side, and a longitudinal axis extending from the front end to the rear end. The bottom of the wall extends from a first point on the first side to a second point on the second side of the floor.

In one aspect, the wall is integrally formed with the floor. The floor and the wall are formed from or include a polymer-fiber composite.

In one aspect, the vehicle further includes a first B-pillar at the first point and a second B-pillar at the second point. The first point and the second point define a line. The line extends substantially orthogonal to the longitudinal axis of the floor.

In one aspect, the elongated console further includes a lateral reinforcement. The lateral reinforcement extends from the first point to the second point. The lateral reinforcement extends substantially orthogonal to the longitudinal axis of the floor.

In one aspect, the elongated console can engage a locking mechanism of a door of the vehicle to maintain the door in a closed position.

In one aspect, the vehicle further includes a seat mounted to the floor. The seat defines a passenger area. The airbag can engage with the passenger area.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top view of a vehicle according to certain aspects of the present disclosure, the vehicle having four seats facing one another with a console disposed in an area between the seats;

FIG. 2 is an isometric view of a base of the console of FIG. 1;

FIG. 3 is a top view of a cover of the console of FIG. 1;

FIG. 4 is a sectional view of an airbag of the console of FIG. 1, the airbag being shown in an inflated state;

FIG. 5 is an isometric view of a display device of the console of FIG. 1;

FIG. 6 is an isometric view of a vehicle frame component according to certain aspects of the present disclosure;

FIG. 7 is an isometric view of another console according to certain aspects of the present disclosure, the console having a recessed cover;

FIG. 8 is an isometric view of yet another console according to certain aspects of the present disclosure, the console including top-deploying airbags and a side-accessible storage compartment;

FIG. 9 is an isometric view of an interior structure for a vehicle according to certain aspects of the present disclosure, the interior structure including a console and a floor that are integrally formed with one another;

FIG. 10 is an isometric view of another interior structure for a vehicle according to certain aspects of the present disclosure, the interior structure including an elongated console and a floor; and

FIG. 11 is an isometric view of a vehicle having an elongated console according to certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

As discussed above, vehicles typically include airbag assemblies that are located in a body of the vehicle, such as in a steering wheel or dashboard. However, certain vehicles include alternative seating arrangements. For example in autonomous vehicles, seats may be arranged in a way that facilitates conversation between passengers, since a traditional driver's seat is not needed. Where the vehicle includes seats arranged in a nontraditional manner, placement of airbags within the body of the vehicle may not be practical.

In various aspects, the present disclosure provides a vehicle console that includes airbags. The console may be disposed within a passenger cabin of the vehicle. For example, the console may be disposed within a center of the vehicle so that one or more seats face the console. The console may generally include a base that defines an inner volume. One or more airbags may be stored within the base so the airbags can deploy from an outer surface of the base. The base may further include a cover that can be opened to provide access to the inner volume so that the console can be used for cargo storage. The console may include other features for passenger convenience, such as a display device, external hardware inputs, cup holders, and/or a stowable table, by way of example. The base may be directly fixed to a frame of the vehicle, or alternatively, integrally formed with a floor of the vehicle.

The console according to various aspects of the present disclosure may advantageously provide a fixed location for airbag storage while also including the passenger convenience features. The fixed location of the airbags may facilitate reliable performance and simple calibration of the airbags. The console may desirably have a high stiffness due to its cross sectional shape parallel to the floor, particularly where the floor and a portion of the console (such as an outer wall) are integrally formed. The high stiffness may contribute to improved performance during impacts. Finally, the console may be formed from or include lightweight polymer-fiber composite materials. Use of the polymer-fiber composite materials may decrease a weight of the vehicle and lead to improved fuel efficiency.

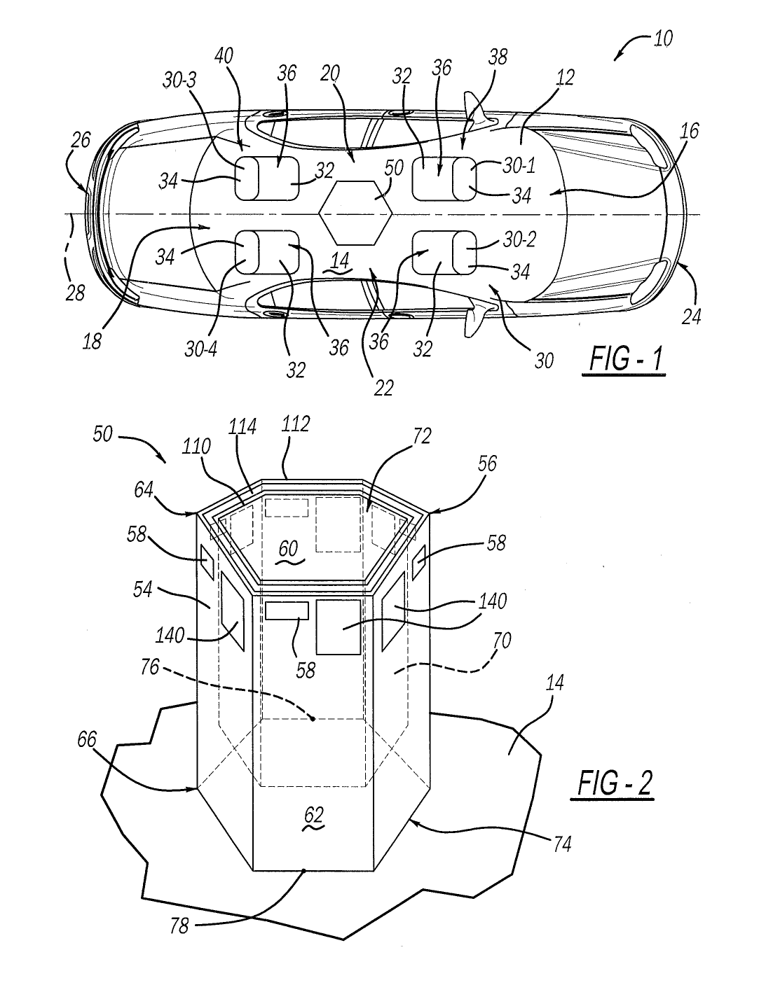

Referring to FIG. 1, a vehicle 10 according to certain aspects of the present disclosure is provided. The vehicle 10 may include a vehicle cabin or passenger cabin 12 having a floor 14. The floor 14 may have a front end 16, a rear end 18, a first side 20, and an opposing second side 22. The front end 16 of the floor 14 may be disposed near a front 24 of the vehicle 10. The rear end 18 of the floor 14 may be disposed near a rear 26 of the vehicle 10. A longitudinal axis 28 of the floor 14 may extend between the front end 16 of the floor 14 and the rear end 18 of the floor 14.

The passenger cabin 12 may further include a plurality of seats 30, each seat 30 including a cushion portion 32 and a back portion 34. The seats 30 may be arranged so that they are facing one another and a center of the vehicle 10. When two seats 30 are facing one another, their respective cushion portions 32 are closer together than their respective back portions 34. Respective passenger areas 36 of each seat 30 may face or be disposed toward passenger areas 36 of the other seats 30. The passenger area 36 is a space that can be occupied by a passenger. In certain aspects, the passenger area 36 also includes an area surrounding the passenger.

In various aspects, the plurality of seats 30 includes four seats: a first seat 30-1, a second seat 30-2, a third seat 30-3, and a fourth seat 30-4. The first seat 30-1 and the second seat 30-2 may be arranged in a first row 38 facing the rear 26 of the vehicle 10. The third seat 30-3 and the fourth seat 30-4 may be arranged in a second row 40 facing the front 24 of the vehicle 10. The first row 38 may be disposed closer to the front 24 of the vehicle 10 than the second row 40. In one example arrangement, the first seat 30-1 faces the third seat 30-3 and the second seat 30-2 faces the fourth seat 30-4. In another example arrangement, the first seat 30-1 faces the fourth seat 30-4 and the second seat 30-2 faces the third seat 30-3 (arrangement not shown). In various alternative aspects, the vehicle 10 includes other quantities of seats 30 or seats 30 arranged differently within the passenger cabin 12.

The passenger cabin 12 may further include a console 50. The console 50 may include airbags (i.e., airbags 116 of FIG. 4) that are configured to deploy and engage with the passenger area 36 of each seat 30, as described in greater detail below. The console 50 may be disposed in the center of the vehicle 10, such as between the first row 38 of seats 30 and the second row 40 of seats 30. As used herein, “center” does not require the console 50 to be disposed equidistant between the front and rear of the vehicle and equidistant between the opposing sides of the vehicle. Rather, the console 50 is generally disposed so that it does not engage the seats 30 or walls of the passenger cabin.

With reference to FIG. 2, the console 50 may include a base 54. The base 54 may include a wall 56 and an airbag assembly, which may be a plurality of airbag assemblies 58. In various aspects, the wall 56 may include an inner surface 60, an outer surface 62, a top 64, and an opposing bottom 66. The outer surface 62 may be a side surface that extends substantially perpendicular to the floor 14. The base 54 may further include an inner volume 70 defined by the inner surface 60. The top 64 may define a top opening 72 in communication with the inner volume 70.

The bottom 66 of the wall 56 may define an area 74 of the floor 14 that is spaced apart from the front end 16, the rear end 18, the first side 20, and the opposing second side 22. Thus, the bottom 66 of the wall 56 may be completely surrounded by floor 14 such that the base 54 is free standing. The bottom 66 of the wall 56 may extend from a first point 76 on the first side 20 of the floor 14 to a second point 78 on the second side 22 of the floor 14.

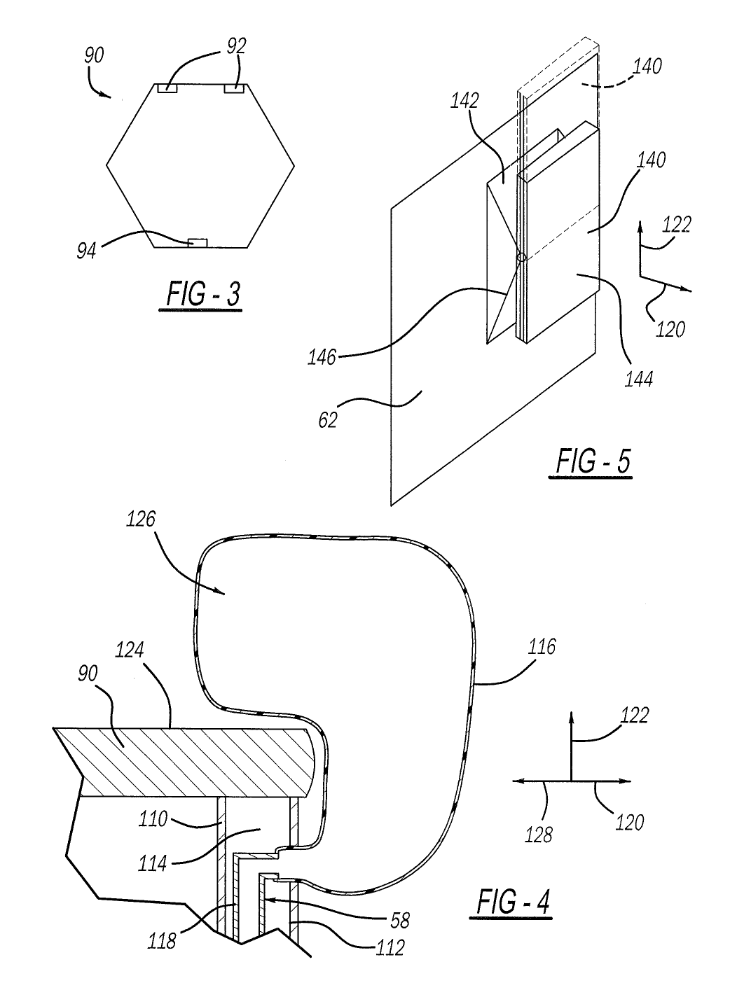

Referring to FIG. 3, the console 50 may further include a door or cover 90 (not shown on FIG. 2) that is movable between an open position and a closed position. In the open position, the inner volume 70 of the base 54 may be accessible from within the passenger cabin 12. In the closed position, the cover 90 may at least partially enclose the inner volume 70. Therefore, passengers can use the inner volume 70 as a storage compartment for cargo (e.g., luggage, groceries, etc.) while traveling in the vehicle 10.

The cover 90 may be coupled to the wall 56. For example, the cover 90 may be coupled to the top 64 of the wall 56 by one or more hinges 92 (e.g., two hinges) and a locking mechanism 94. The cover 90 may pivot about the hinges 92 to move between the open position and the closed position. In various alternative embodiments, the cover 90 is coupled to the outer surface 62 of the base to provide access to the inner volume 70 from a side opening (see, e.g., FIG. 8).

Returning to FIG. 2, the wall 56 may include an inner wall 110 and an outer wall 112. The outer wall 112 may at least partially surround the inner wall 110. The inner wall 110 and the outer wall 112 may cooperate to define a gap 114. As shown in FIG. 4, the airbag assemblies 58, each including an airbag 116, an airbag inflator 118, and optionally other components (not shown), may be disposed within the gap 114. In alternative aspects, when the wall 56 is a single wall, the plurality of airbag assemblies 58 may be disposed within the inner volume 70.

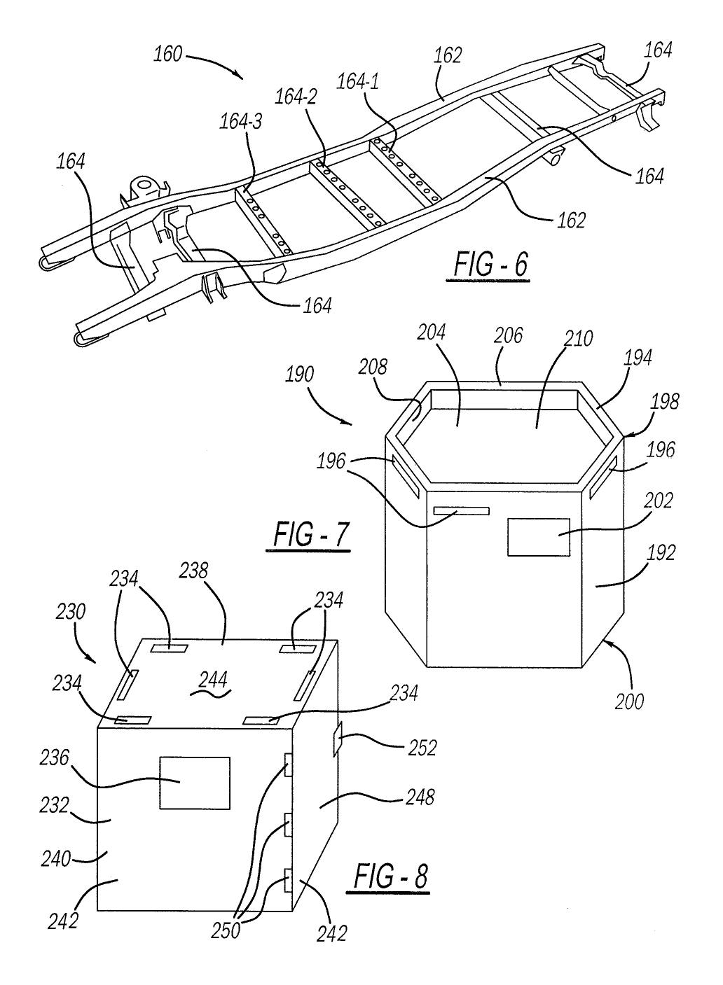

The plurality of airbags 116 may be disposed within the base 54 in a packaged state (FIG. 2) and configured to deploy to an inflated state (FIG. 4). The plurality of airbags 116 may be arranged within the base 54 so that they can deploy into the passenger areas 36. In the packaged state, the plurality of airbag assemblies 58 may be flush-mounted with the outer surface 62. However, those skilled in the art will appreciate that the plurality of airbag assemblies 58 can be mounted in other manners within the base 54 that are functional, safe, and aesthetic. The plurality of airbag assemblies 58 may be mounted at a predetermined fixed location with respect to a frame of the vehicle 10 (see, e.g., vehicle frame 160 of FIG. 6). Thus, a position of the airbag assemblies 58, when in the packaged state, does not change with respect to the vehicle frame.

In the packaged state, the plurality of airbag assemblies 58 may be disposed below the cover 90 (i.e., between the cover 90 and the bottom 66 of the base 54). The plurality of airbag assemblies 58 may be disposed far enough below the cover 90 so that the cover 90 does not interfere with deployment of the airbags 116. Furthermore, the cover 90 may remain closed and latched (i.e., the locking mechanism 94 remains engaged) when the plurality of airbags 116 deploys. Thus, deployment of the plurality of airbags 116 does not engage the locking mechanism 94 of the cover 90. Because the plurality of airbag assemblies 58 is fixed with respect to the vehicle frame, accuracy of calibration of the airbag assemblies 58 is improved compared to systems having variable position airbags (e.g., where the airbag is located in a movable cover or a height-adjustable wall).

With reference to FIG. 4, the airbag 116 is shown in the inflated state. Each airbag 116 may deploy from the outer surface 62 of the base 54. More particularly, each airbag 116 may deploy from the outer surface 62 of the outer wall 112. In the inflated state, each airbag 116 may extend outward in a first direction 120 and upward in a second direction 122. An inwardly-extending portion 126 of the airbag 116 may extend at least partially over a top surface 124 of the cover 90 in a third direction 128 opposite the first direction 120. In certain aspects, the plurality of airbag assemblies 58 is arranged around a perimeter of the top 64 of the base 54 and the airbags 116 are configured to deploy concurrently so that the inwardly-extending portions 126 of each airbag 116 act to bias any items disposed on the top surface 124 of the cover 90 to the center of the cover 90. Those skilled in the art will appreciate the plurality of airbags 116 may have a variety of shapes and sizes, depending on the seat arrangement. The console 50 may include additional pluralities of airbags having different shapes, sizes, placements within the console, and deployment characteristics.

The design of the console 50, and more particularly the geometric shape, may be optimized to meet stiffness requirements. Returning to FIG. 2, the wall 56, and more particularly the outer wall 112, may define a planar cross section parallel to the floor 14. The cross section may substantially define a geometric shape, such as a hexagon, as shown. The geometric shape may be selected based on the arrangement of the plurality of seats 30 within the passenger cabin 12. In various alternative aspects, the geometric shape is selected from the group consisting of: a circle, an oval, a quadrilateral (see, e.g., wall 238 of FIG. 8), a triangle, a pentagon, a hexagon, a heptagon, an octagon, a nonagon, and a decagon, by way of example. The geometric shape may optionally be equilateral. The console 50 having the cross section defined by the geometric shapes described above may have an improved stiffness compared to other structures, such as a post or pedestal.

The inner wall 110 may define another cross section parallel to the floor 14, the cross section defining another geometric shape. The geometric shape of the cross section of the inner wall 110 may be similar to the geometric shape of the cross section of the outer wall 112. For example, the inner wall 110 may define the same geometric shape as the outer wall 112. In alternative aspects, the outer wall 112 and the inner wall 110 may define distinct geometric shapes. For example, the outer wall 112 may define a rectangle and the inner wall 110 may define an oval having a smaller size than the rectangle.

The console 50 may include different or additional features such as vehicle systems and/or user convenience features. Vehicle systems include heating, ventilation, and cooling (HVAC), a user interface device (UID), a global positioning system (GPS), and an external communication system, by way of example. User convenience features include display devices (see, e.g., monitors 140 of FIGS. 2 and 5), external hardware inputs, beverage holders, storage pockets, tray tables or desks, and holographic display devices, by way of example. The console 50 may include any components that do not interfere with the function of the plurality of airbag assemblies 58.

With reference to FIG. 5, the console 50 may include a plurality of displace devices, such as monitors 140. Each monitor 140 may be movable between a stowed position (FIG. 2) and an extended position (FIG. 5). In the stowed position, the monitor 140 may be disposed in a cutout or a depression 142 formed in the wall 56. A surface 144 of the monitor 140 may be flush or alternatively recessed with respect to the outer surface 62 of the base 54 when the monitor 140 is in the stowed position.

Each monitor 140 may be coupled to a linkage mechanism 146 to facilitate movement of the monitor 140 between the stowed position and the extended position. For example, a user can pull the monitor 140 outward in the first direction 120 and then slide the monitor 140 upward in the second direction 122. The monitor 140 may also be tiltable so that the user can control an angle of the monitor 140 with respect to the outer surface 62. In various aspects, motion of the monitor 140 between the stowed position and the extended position is automated and can be initiated by pressing a button or interacting with a UID (not shown).

Materials of construction for the console 50 may be selected to optimize stiffness of the console 50. For example, the console 50 may be constructed from a polymer-fiber composite material, or a combination of a polymer-fiber composite material and foam. Polymer-fiber composite materials may include a polymer matrix having reinforcing fibers distributed therein. The polymer matrix may include thermoplastic resins or thermoset resins.

The thermoplastic resin may include: polyethylenimine (PEI), polyamide-imide (PAI), polyamide (PA) (e.g., nylon 6, nylon 66, nylon 12), polyetheretherketone (PEEK), polyetherketone (PEK), a polyphenylene sulfide (PPS), a thermoplastic polyurethane (TPU), polypropylene (PP), polycarbonate/acrylonitrile butadiene styrene (PC/ABS), high-density polyethylene (HDPE), polyethylene terephthalate (PET), poly(methyl methacrylate) (PMMA), polycarbonate (PC), polyaryletherketone (PAEK), polyetherketoneketone (PEKK), co-polymers thereof, and combinations thereof. The thermoset polymers may include: benzoxazine, a bismaleimide (BMI), a cyanate ester, an epoxy, a phenolic (PF), a polyacrylate (acrylic), a polyimide (PI), an unsaturated polyester, a polyurethane (PUR), a vinyl ester, a siloxane, polydicyclopentadiene (PDCPD), co-polymers thereof, and combinations thereof.

The reinforcing fibers may include: carbon fibers, glass fibers (e.g., fiber glass, quartz), basalt fibers, aramid fibers (e.g., KEVLAR®, polyphenylene benzobisoxazole (PBO), polyethylene fibers (e.g., ultra-high molecular weight polyethylene (UHMWPE)), polypropylene fibers (e.g., high-strength polypropylene) natural fibers (e.g., cotton, flax, cellulose, spider silk), and combinations thereof. The reinforcing fibers may be fabricated as woven fabric, continuous random fabric, discontinuous random fibers, chopped random fabric, continuous strand unidirectional plies, oriented chopped strand plies, braided fabric, and combinations thereof.

As appreciated by those of skill in the art, the composite material may further include other conventional ingredients, including other reinforcement materials, functional fillers or additive agents, like organic/inorganic fillers, fire-retardants, anti-ultraviolet radiation agents (UV stabilizers), anti-oxidants, colorants, mold release agents, softeners, plasticizing agents, surface active agents, and the like.

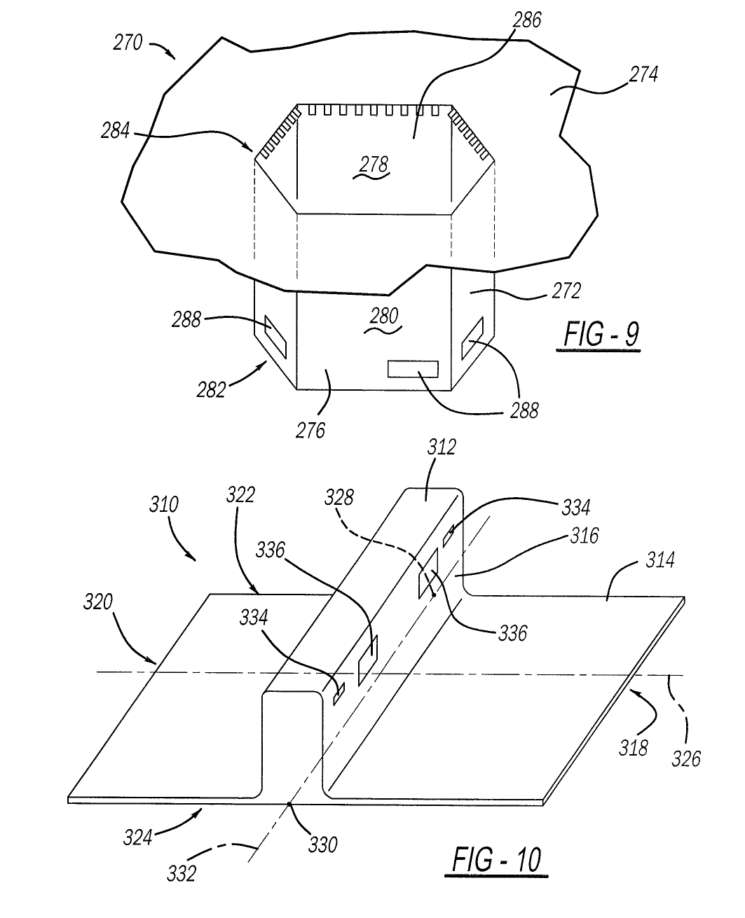

The console 50 may be secured to the vehicle 10 by coupling the bottom 66 of the base 54 to the vehicle structure (see vehicle frame 160 of FIG. 6), or alternatively by integrally forming the console 50 and the floor 14 (see, e.g., interior structure 270 of FIG. 9). Referring to FIG. 6, a portion of a vehicle frame 160 according to certain aspects of this present disclosure is provided. The vehicle frame 160 may include two opposing longitudinal rails 162. The vehicle frame 160 may further include a plurality of cross beams 164 extending between the opposing longitudinal rails 162. The cross beams 164 may include a first cross beam 164-1, a second cross beam 164-2, and a third cross beam 164-3. The console 50 (FIGS. 1-5) may be coupled to the second cross beam 164-2 and the plurality of seats 30 (FIG. 1) may be coupled to the first and third cross beams 164-1, 164-3. More particularly, the first and second seats 30-1, 30-2 of the first row 38 may be coupled to the first cross beam 164-1 and the third and fourth seats 30-3, 30-4 may be coupled to the third cross beam 164-3 of the second row 40. In various aspects, the console 50 is directly coupled to the vehicle frame 160.

A console according the present disclosure may include different cover configurations (FIG. 7), airbag arrangements (FIG. 8), and cross sectional shapes (FIGS. 8, 10). With reference to FIG. 7, another console 190 for a passenger cabin of a vehicle according to various aspects of the present disclosure is provided. The console 190 may include a base 192 having a wall 194 and a plurality of airbags 196 disposed therein. The base 192 may extend between a top 198 and a bottom 200. The base 192 may further include a display device 202 coupled to the wall 194. The base 192 may be similar to the base 54 of the console 50 of FIGS. 1-5.

The console 190 may further include a cover 204 that is recessed with respect to a top surface 206 of the base 192. A portion of the wall 194 at the top 198 of the base 192 may therefore define a lip 208 that extends above the cover 204. The lip 208 may form a perimeter around the cover 204. Passengers can use a top surface 210 of the cover 204 as a table or storage area. The lip 208 acts as a barrier to prevent objects disposed on the top surface 210 from sliding off of the console 190 during operation of the vehicle. The recessed cover 204 can also advantageously increase a clearance distance between objects on the top surface 210 and the plurality of airbags 196 in the inflated state.

Although the consoles 50, 190 discussed above include side-deploying airbags, a console may additionally or alternatively include top-deploying airbags. With reference to FIG. 8, yet another console 230 according to various aspects of the present disclosure is provided. The console 230 may include a body 232, a plurality of top-deploying airbags 234, and a display device 236. The body 232 may have a wall 238, which may include an inner wall (not shown) and an outer wall 240. The outer wall 240 may define a planar cross section parallel to a floor (not shown) of the vehicle. The cross section may substantially define a quadrilateral, such as a rectangle. The outer wall 240 may define side surfaces 242 and a top surface 244 that extends between and connects the side surfaces 242. The plurality of airbags 234 may deploy from the top surface 244. The display device 236 may be coupled to the side surface 242 of the outer wall 240.

The inner wall (not shown) may define an inner volume (not shown) similar to the inner volume 70 of the console 50 of FIGS. 1-5. The inner volume can be used as a storage compartment. The console 230 may further include a door 248 that is movable between an open position and a closed position. The door 248 may be coupled to the body 232 by a plurality of hinges 250 and a locking mechanism 252. In the closed position, the door 248 at least partially encloses the inner volume. The door 248 can be opened to provide access to the inner volume.

As discussed above, a console for a vehicle may optionally be integrally formed with a floor of the vehicle. An interior structure that includes an integrally formed console and floor may have improved torsional stiffness compared to a console that is directly coupled to a vehicle frame. Referring to FIG. 9, a partial interior structure 270 according to various aspects of the present disclosure is provided. The interior structure 270 may include a console 272 and a floor 274. The console 272 may include a wall 276 that is integrally formed with the floor 274. Both the wall 276 and the floor 274 may be formed from or include a polymer-fiber composite material, such as those described above.

The wall 276 may have an inner surface 278 and an outer surface 280. The inner surface 278 of the wall 276 may define an inner volume 286. The wall 276 may extend between a top 282 and an opposing bottom 284. The floor 274 may extend outwardly from the bottom 284 of the wall 276 with respect to the inner volume 286. The console 272 may include an airbag 288 that is disposed within the inner volume 286. The airbag 288 may be configured to deploy from the outer surface 280 of the wall 276. While the airbag 288 is shown as being disposed on a side of the console 272, the airbag 288 may alternatively be disposed on a top surface (not shown) of the console 272, similar to the airbags 234 of the console 230 of FIG. 8.

In various aspects, the wall 276 may be an outer wall and the console 272 may further include an inner wall (not shown). Except as otherwise described, the inner wall and outer wall 276 may be similar to the inner wall 110 and outer wall 112 of the console 50 of FIGS. 1-5. Thus, the airbag 288 may be disposed within a gap (not shown) defined by the inner wall and the outer wall 276. The console 272 may also include other features described above and not shown in FIG. 9, such as a cover or door (see, e.g., cover 90 of FIG. 3, cover 204 of FIG. 7, door 248 of FIG. 8), a display device (see, e.g., monitors 140 of FIG. 5), and/or other vehicle systems and passenger convenience features.

In various aspects, the present disclosure provides a method of manufacturing an integrally-formed interior structure, such as the interior structure 270 of FIG. 9. The method may include: (1) forming the floor 274 and the wall 276 together in a composites manufacturing process; (2) optionally forming the cover or door and inner wall in a composites manufacturing process; (3) creating compartments for the airbag 288 and other features such as monitors in secondary trimming operations; (4) coupling the inner wall, cover, airbag 288, and other components to the interior structure 270. The interior structure 270 may be coupled to a vehicle, such as in a passenger cabin.

Vehicles typically include a plurality of vertical pillars, such as A-pillars, B-pillars, and C-pillars. A pair of A-pillars may be disposed on either side of the vehicle near a front of the vehicle (e.g., in front of a row of front side doors on a typical vehicle). A pair of C-pillars may be disposed on either side of the vehicle near a rear of the vehicle (e.g., behind a row of rear side doors on the typical vehicle). A pair of B-pillars may be disposed on either side of the vehicle, in between the A-pillars and the C-pillars (e.g., between the first row of doors and the second row of doors on the typical vehicle). Vehicle doors are commonly hinged at the pillars. For example in a four-door sedan, front doors are hinged at A-pillars and rear doors are hinged at B-pillars.

Some vehicles, however, include doors that are coupled to the vehicle at locations other than B-pillars. For example, certain vehicles include doors that are pivotally connected to the A-pillars and/or C-pillars. When the vehicle doors are not connected at the B-pillars, alternative console configurations are possible. With reference to FIG. 10, another interior structure 310 according to certain aspects of the present disclosure is provided. The interior structure 310 may be included in a passenger cabin of a vehicle having doors that are hinged at the A-pillars and the C-pillars, rather than the B-pillars (not shown). The interior structure 310 may include an elongated console 312 and a floor 314. The elongated console 312 may include a wall 316. In various aspects, the floor 314 is integrally formed with the wall 316. Unless otherwise described, the interior structure 310 may be similar to the interior structure 270 of FIG. 9.

The floor 314 may have a front end 318, a rear end 320, a first side 322, and an opposing second side 324. A longitudinal axis 326 may extend between the front end 318 and the rear end 320. The elongated console 312 may extend from a first point 328 on the first side 322 of the floor 314 to a second point 330 on the second side 324 of the floor 314. The first point 328 and the second point 330 may define a line 332 that extends substantially orthogonal to the longitudinal axis 326 of the floor 314. A first B-pillar may extend adjacent to the first point 328 on the floor 314 and a second B-pillar may extend adjacent to the second point 330 on the floor 314. Thus, the elongated console 312 may extend across the entire passenger cabin. The elongated console 312 may include a plurality of airbags 334 and a plurality of display devices 336.

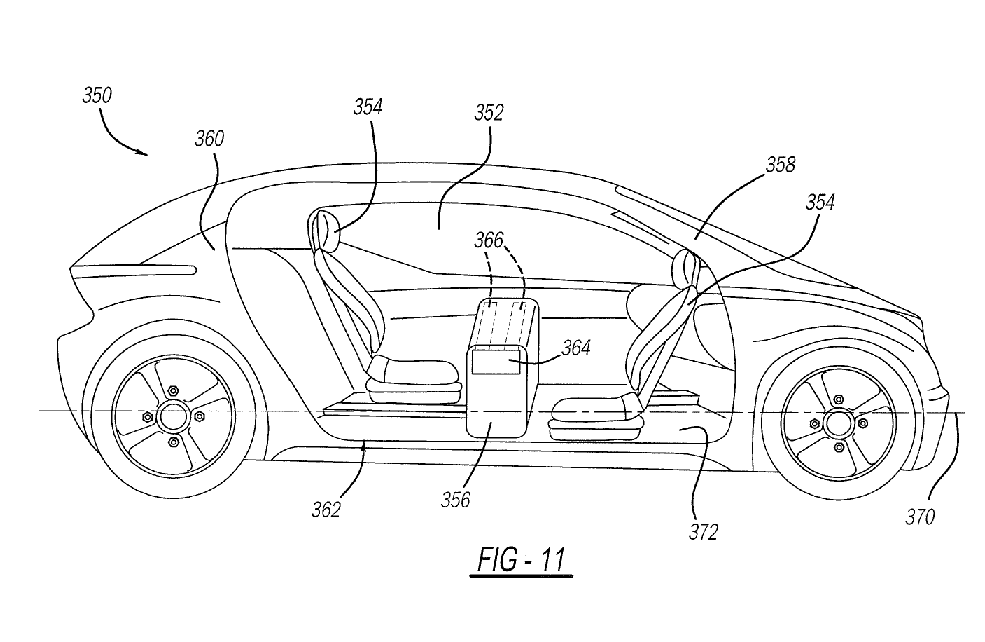

Certain other vehicles do not include B-pillars at all. In vehicles that omit B-pillars, a console may provide an engagement location for doors of the vehicle, as well as lateral support. With reference to FIG. 11, a vehicle 350 according to certain aspects of the present disclosure is provided. The vehicle 350 may include passenger cabin 352, a plurality of seats 354, and an elongated console 356. The elongated console 356 may be similar to the elongated console 312 of FIG. 10, except as described below. The vehicle 350 may include a pair of A-pillars 358 and a pair of C-pillars 360, but be free of intermediate B-pillars. The elongated console 356 may extend between a first side 362 of the vehicle 350 and a second side of the vehicle 350 opposite the first side 362.

The elongated console 356 may include a pair of facing plates 364. The facing plates 364 may be configured to engage locking mechanisms of vehicle doors. For example, vehicle doors in a first row are hinged at the A-pillars and having locking mechanisms that engage the elongated console 356 at the facing plates 364. Vehicle doors in a second row are hinged at the C-pillars and having locking mechanisms that engage the elongated console 356 at the facing plate 364. The elongated console 356 may further include one or more lateral reinforcements 366 disposed within an inner volume of the elongated console 356. The lateral reinforcements 366 may extend substantially orthogonal to a longitudinal axis 370 of a floor 372 of the passenger cabin 352. The lateral reinforcements 366 may provide support to the doors, particularly in the case of a side impact.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A console for a cabin of a vehicle having a floor, the console comprising:
a base comprising:
a wall having an inner surface, an outer surface, a top, and an opposing bottom, the inner surface defining an inner volume and the top defining a top opening of the inner volume;
an airbag configured to deploy from the outer surface of the wall; and
a cover coupled to the wall, configured to be movable between an open position and a closed position, wherein the cover at least partially encloses the inner volume when in the closed position.

2. The console of claim 1, wherein a position of the airbag is fixed with respect to a frame of the vehicle.

3. The console of claim 1, wherein the wall comprises an inner wall and an outer wall, the inner wall and the outer wall cooperating to define a gap into which the airbag is disposed.

4. The console of claim 3, wherein one of the inner wall and the outer wall is integrally formed with the floor.

5. The console of claim 1, wherein the wall comprises a polymer-fiber composite material.

6. The console of claim 1, wherein the wall has a planar cross section parallel to the floor, the cross section substantially defining a geometric shape that is a circle, an oval, a triangle, a quadrilateral, a pentagon, a hexagon, a heptagon, or an octagon.

7. The console of claim 1, wherein:
the bottom of the wall is in communication with the floor of the cabin, the floor having a front end, a rear end, a first side, an opposing second side, and a longitudinal axis extending from the front end to the rear end; and
the bottom of the wall defines an area of the floor that is spaced apart from the front end, the rear end, the first side, and the opposing second side.

8. The console of claim 1, further comprising a display device coupled to the base and configured to be visible from within the cabin.

9. A vehicle cabin comprising the console of claim 1, the vehicle cabin comprising a seat in communication with the floor, the seat defining a passenger area, wherein the airbag is configured to engage with the passenger area.

10. The vehicle cabin of claim 9, further comprising a plurality of additional seats in communication with the floor, each of the additional seats defining an additional passenger area, wherein the console comprises an additional airbag configured to engage with the additional passenger area of each of the additional seats.

11. The vehicle cabin of claim 10, wherein the passenger area of the seat faces the passenger area of at least one seat of the plurality of additional seats.

12. An interior structure for a vehicle, the interior structure comprising:
a console comprising:
a wall comprising a polymer-fiber composite, the wall having an inner surface, an outer surface, a top, and an opposing bottom, the inner surface defining an inner volume; and
an airbag configured to deploy from a surface of the console; and
a floor extending outwardly from the bottom of the wall with respect to the inner volume, the floor being integrally formed with the wall and comprising the polymer-fiber composite.

13. The interior structure of claim 12, wherein the console further comprises an inner wall at least partially disposed within the inner volume, the wall and the inner wall cooperating to define a gap into which the airbag is disposed.

14. The interior structure of claim 13, wherein:
the top of the wall defines an opening; and
the console further comprises a cover coupled to the top of the wall, the cover being configured to be movable between an open position and a closed position, wherein the cover at least partially encloses the inner volume when in the closed position.

15. A vehicle having a cabin, the vehicle comprising:
an elongated console comprising:
a wall having an inner surface, an outer surface, a top, and an opposing bottom, the inner surface defining an inner volume; and
an airbag configured to deploy from a surface of the wall, a position of the airbag being fixed with respect to a frame of the vehicle; and
a floor having a front end, a rear end, a first side, an opposing second side, and a longitudinal axis extending from the front end to the rear end, wherein the bottom of the wall extends from a first point on the first side to a second point on the second side of the floor.

16. The vehicle of claim 15, wherein the wall is integrally formed with the floor, the floor and the wall comprising a polymer-fiber composite.

17. The vehicle of claim 15, further comprising a first B-pillar at the first point and a second B-pillar at the second point, the first point and the second point defining a line substantially orthogonal to the longitudinal axis of the floor.

18. The vehicle of claim 15, wherein the elongated console further comprises a lateral reinforcement extending from the first point to the second point, the lateral reinforcement extending substantially orthogonal to the longitudinal axis of the floor.

19. The vehicle of claim 18, wherein the elongated console is configured to engage a locking mechanism of a door of the vehicle to maintain the door in a closed position.

20. The vehicle of claim 15, further comprising a seat mounted to the floor, the seat defining a passenger area, wherein the airbag is configured to engage with the passenger area.
